(19) United States
(12) Patent Application Publication
(10) Pub. No.: US 2003/0091121 A1
(43) Pub. Date: May 15, 2003

(54) Multi-valued FSK communication method and multi-valued FSK communication apparatus

(75) Inventor: Nobuhiko Kenmochi, Shiojiri-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/292,520

(22) Filed: Nov. 13, 2002

(30) Foreign Application Priority Data
Nov. 14, 2001 (JP) 2001-349108

(51) Int. Cl. H04L 27/10

(52) U.S. Cl. 375/272

(57) ABSTRACT

To provide a multi-valued FSK communication method and a multi-valued FSK communication apparatus having a simplified circuit configuration for receiving a multi-valued FSK packet. A transmitter side transmits a packet including a synchronization signal part using the maximum value and the minimum value of multi-valued FSK and a payload part using all values of multi-valued FSK. A receiver side receives the packet, and a reception circuit 3 forms an analog demodulation signal Sda by demodulating a reception signal and a binary signal Sb by binarizing the analog demodulation signal Sdm. These signals Sda and Sb are supplied to a received data processing unit 23 of a baseband signal processor 12. The received data processing unit 23 establishes synchronization based on the binary signal Sb. Also, after synchronization is established, a reference value used for converting a digital demodulation signal to a multi-valued digital signal is corrected based on the digital demodulation signal Sdd, which corresponds to a synchronization signal part, generated by A/D-converting the analog demodulation signal Sda.

### BACKGROUND OF THE INVENTION

1 Field of Invention

The present invention relates to a multi-valued FSK communication method and a multi-valued FSK communication apparatus, in which a transmitter side performs multi-valued frequency shift keying (FSK) to a packet frame including a synchronization signal part and a payload part so as to transmit the packet frame, and a receiver side receives and demodulates the packet frame.

2. Description of Related Art

As this type of multi-valued FSK communication method, a method disclosed in Japanese Unexamined Patent Application Publication No. 2000-7821 (hereinafter, referred to as a first known art), a method disclosed in Japanese Unexamined Patent Application Publication No. 8-237314 (hereinafter, referred to as a second known art), a method disclosed in Japanese Unexamined Patent Application Publication No. 9-18526 (hereinafter, referred to as a third known art), and a method disclosed in Japanese Unexamined Patent Application Publication No. 9-224058 (hereinafter, referred to as a fourth known art) are known.

The first known art discloses a four-valued FSK receiver and a method for determining a signal. In this method, when a received four-valued FSK signal is converted to a four-valued digital code, an average circuit calculates the average of a demodulation signal and a waveform-forming circuit constantly and gradually performs a process of increasing/deceasing the total value of a digital signal so that the average obtained in the average circuit becomes a second reference value. Accordingly, effects of variation in the median value of the demodulation signal are alleviated. Also, in a reference value generating circuit, the frequency with which a four-valued FSK signal appears above or below the reference value is counted by using a counter, and a first and third reference values are corrected based on a result of counting.

The second known art discloses a four-valued FSK demodulation circuit and a digital demodulation method for a multi-valued level signal. Herein, a plurality of reference voltages used for demodulating a multi-valued signal are generated based on the average of AC component in a specific signal pattern interval in a baseband signal and on an amplitude value of the AC component, and the plurality of reference voltages are held. When a multi-valued signal is received, levels of the multi-valued signal are discriminated by using the plurality of reference signals and a corresponding digital value is demodulated.

Further, the third known art discloses a four-valued information radio signal receiver. The receiver, which is a pager, includes a control unit having a differentiation circuit, an integration circuit, and a CPU for determining four-value, a four-valued analog signal output from an intermediate frequency processing unit is differentiated by the differentiation circuit so as to obtain the amount of variation in a signal level, the amount of variation in the signal level is integrated by the integration circuit so as to obtain a pulse signal having a width proportional to the amount of variation of the signal level, the level of the pulse signal is set in accordance with positive and negative of a differentiation signal, and the CPU determines the four-value based on a known value of a synchronization signal and the width and level of the pulse signal.

The fourth known art discloses a bit synchronization circuit and a bit synchronization method, in which a polarity-determined output signal and a level-determined output signal of a transmission signal demodulated from binary or four-valued FSK are input, the change in the polarity-determined output signal is sampled and delayed so as to generate a first sampling output, the change in the level-determined output signal is sampled and delayed so as to generate a second sampling output having a predetermined time relationship with the first sampling output, and, when the first and second sampling outputs and a phase signal specifying the correction range of a counter circuit reach a predetermined level, a correction signal is output to the counter circuit. Accordingly, the clock of the counter circuit is matched to the transmission speed of the transmission signal.

In the first known art, there is an unsolved problem as follows. The frequency with which a four-valued FSK signal appears above or below the reference value in a data signal unit is counted by the counter and the amplitude as well as the average of the four-valued FSK signal is detected based on the result of counting so as to adequately correct the reference values for slicing. Accordingly, more stable slice can be performed even if a drift is generated in a signal compared to the method in which a reference value is set only at a synchronization detecting unit, which is advantageous. However, an inadequate symbol pattern (for example, collapse of the symbol pattern) in a user data unit may be caused when the frequency with which a four-valued FSK signal appears above or below the reference value is counted. In this case, a slice error is more likely to occur. Also, a memory for storing the frequency of appearance is required and thus the scale of hardware is disadvantageously increased.

In the second known art, there is an unsolved problem as follows. A synchronization signal, which is a binary 01 pattern corresponding to four-valued 00 and 01 among an FM detection output, is smoothed so as to detect a median value, and the synchronization signal is rectified and smoothed so as to detect an amplitude. Accordingly, a reference value for slice of a subsequent four-valued FSK data signal can be obtained. Basically, the process is performed in an analog circuit and the following is defined as a premise: a synchronization signal can be detected with a predetermined timing as in the TDMA method of mobile phones. When a packet in which a synchronization signal does not have a 01 pattern is used as in a short-range radio communication method using the ISM band, the median value can be detected by smoothing, but it is difficult to stably detect the reference value for slice of four-valued FSK by rectification and smoothing.

In the third known art, there is an unsolved problem as follows. Effects of drift of an input signal can be eliminated by differentiating a four-valued FSK signal so as to obtain the amount of variation from the previous symbol and by integrating the amount of variation from the synchronization detecting unit. However, the integration from the synchronization detecting unit cannot be applied to a long packet, considering that noise is generated during integration.

In the fourth known art, there is an unsolved problem as follows. When synchronization information is detected from a transition timing of a signal in four-valued FSK, a slight stagger generated at the detected synchronization timing can be canceled by determining from which state (00, 01, 10, and 11) the signal is changed. The detection using the transition of the signal is not affected by a drift. However, the stability is essentially low, and thus this detection cannot be applied to a short-range radio communication method using the ISM band.

On the other hand, the following method is used in order to detect a synchronization signal part in radio communication using a packet. As shown in FIG. 7, in a binary FSK receiver, an analog signal to be demodulated in a reception circuit 101 is supplied to a low-pass filter 102 and smoothed, the smoothed signal is used as a threshold of an analog slicer 103 so as to slice an analog demodulation signal, and the sliced signal is supplied to a baseband processing unit 104 for performing digital processing as a digital signal of 0 or 1. In the baseband processing unit 104, a symbol synchronization circuit 105 performs symbol synchronization so as to form a clock signal and the clock signal is supplied to a correlator 106. Then, the correlator 106 detects the synchronization signal part placed at the top of a packet. In this case, the correlator 106 can be simply configured, that is, the correlator 106 includes a shift register for sequentially shift-inputting sequential symbols whose quantifying bit number is 1, and an accumulator.

However, the configuration shown in FIG. 7 is for binary FSK and is not for four-valued FSK, because the slice level is not stabilized in four-valued FSK in which a signal level has four stages.

Accordingly, another method is proposed. In this method, as shown in FIG. 8, an analog signal to be demodulated in a reception circuit is supplied to a baseband processing unit 104 for performing digital processing, the analog signal is converted to a digital signal by an A/D converter 107 of the baseband processing unit 104, and then a correlator 108 performs synchronization detection and correction of a reference level of a digital slicer 109. In this method shown in FIG. 8, since the digital signal generated by A/D-converting the analog signal in the A/D converter 107 has a quantization level of about 6 bits, the scale of the hardware of the correlator (shift register and accumulator) increases in proportion to the quantization level, and power consumption is also increased accordingly. This problem is caused because an adequate determination of the slice level must be performed at the same time as synchronization, and thus a multi-bit symbol must be input to the correlator 108.

The present invention has been made in view of the above-described unsolved problems in the known arts. It is an object of the present invention to provide a multi-valued FSK communication method and a multi-valued FSK communication apparatus in which the scale of hardware of a baseband processing unit is decreased and power consumption can be reduced by inputting an analog signal and a sliced digital signal from a reception circuit to the baseband processing unit.

### SUMMARY OF THE INVENTION

In order to achieve the above described object, in the multi-valued FSK communication method according to claim 1, a transmitter side forms a transmission signal by multi-valued FSK modulating a packet including a synchronization signal part and a payload part and transmits the transmission signal to a receiver side, the receiver side receives the transmission signal and A/D-converts an analog demodulation signal generated by demodulating a reception signal so as to compare with a reference value, so that a multi-valued digital signal is generated. The method comprises: in the transmitter side, forming the transmission signal by performing multi-valued FSK modulation using only the minimum value and the maximum value in multi-valued FSK with respect to the synchronization signal part of the packet and by performing normal multi-valued FSK modulation with respect to the payload part; and transmitting the transmission signal to the receiver side. Also, the method comprises: in the receiver side, outputting the analog demodulation signal and a binary signal generated by binarizing the analog demodulation signal from a reception circuit unit for demodulating the reception signal to a baseband processing unit; and in the baseband processing unit, correcting the reference value for determining the level of multi-valued FSK based on the digital demodulation signal generated by A/D-converting the analog demodulation signal after synchronization is established based on the binary signal, and A/D-converting the payload part of the analog demodulation signal so as to compare with the reference value, thereby generating the multi-valued digital signal.

Also, in the multi-valued FSK communication method according to claim 2, when the frame of the payload part of the packet is long, the transmitter side inserts an auxiliary synchronization signal part corresponding to the synchronization signal part into the payload part with an interval of predetermined time from the end of the synchronization signal part, the baseband processing unit in the receiver side measures the predetermined time from the end of the synchronization signal part, synchronization is established based on the binary signal output from the reception circuit unit every time the predetermined time passes, and the reference value is corrected by using the digital demodulation signal.

Further, in the multi-valued FSK communication method according to claim 3, in the invention of claim 1 or 2, the multi-valued FSK is set to four-valued FSK.

In the multi-valued FSK communication apparatus according to claim 4, a transmitter forms a transmission signal by multi-valued FSK modulating a packet including a synchronization signal part and a payload part and transmits the transmission signal to a receiver, and the receiver receives the transmission signal and A/D-converts a demodulation signal generated by demodulating a reception signal so as to compare with a reference value, so that a multi-valued digital signal is generated. The transmitter comprises transmission means for forming the transmission signal by performing multi-valued FSK modulation using only the minimum value and the maximum value in multi-valued FSK with respect to the synchronization signal part of the packet and by performing normal multi-valued FSK modulation with respect to the payload part and for transmitting the transmission signal to the receiver. The receiver comprises: a reception circuit unit for outputting the analog demodulation signal generated by demodulating the reception signal and a binary signal generated by binarizing the analog demodulation signal; and a baseband processing unit including synchronization establishing means for establishing synchronization based on the binary signal output from the reception circuit unit; reference value correcting means for correcting the reference value for determining the level of multi-valued FSK based on the digital signal generated by A/D-converting the analog reception signal in the synchronization signal part in a state that the synchronization establishing means has established synchronization; and code determining means for generating the multi-valued digital signal by A/D-converting the analog demodulation signal so as to compare with the reference value.

Also, in the multi-valued FSK communication apparatus according to claim 5, in the invention of claim 4, the transmitter inserts an auxiliary synchronization signal part corresponding to the synchronization signal part into the payload part with an interval of predetermined time from the end of the synchronization signal part when the frame of the payload part of the packet is long. The baseband processing unit in the receiver comprises auxiliary synchronization signal position detecting means for detecting the position of an auxiliary synchronization signal by measuring the predetermined time from the end of the synchronization signal part. The synchronization establishing means establishes synchronization based on the binary signal output from the reception circuit unit when the auxiliary synchronization signal position detecting means detects the auxiliary synchronization signal. The reference value correcting means corrects the reference value by using the digital demodulation signal.

Further, in the multi-valued FSK communication apparatus according to claim 6, in the invention of claim 4 or 5, the multi-valued FSK is set to four-valued FSK.

### BRIEF DESCRIPTION OF THE DRAWINGS

FIG. 1 is a block diagram showing an embodiment of the present invention.

FIG. 2 is a block diagram showing a specific configuration of a received data processing unit 23 shown in FIG. 1.

FIG. 3 shows an example of a packet.

FIG. 4 shows a four-valued FSK signal of the packet.

FIG. 5 shows a modification of the packet.

FIG. 6 is a flowchart showing an example of a process of establishing synchronization.

FIG. 7 is a block diagram showing a known synchronization establishment circuit.

FIG. 8 is a block diagram showing another known synchronization establishment circuit.

### DETAILED DESCRIPTION OF PREFERRED EMBODIMENTS

Hereinafter, an embodiment of the present invention will be described with reference to the drawings.

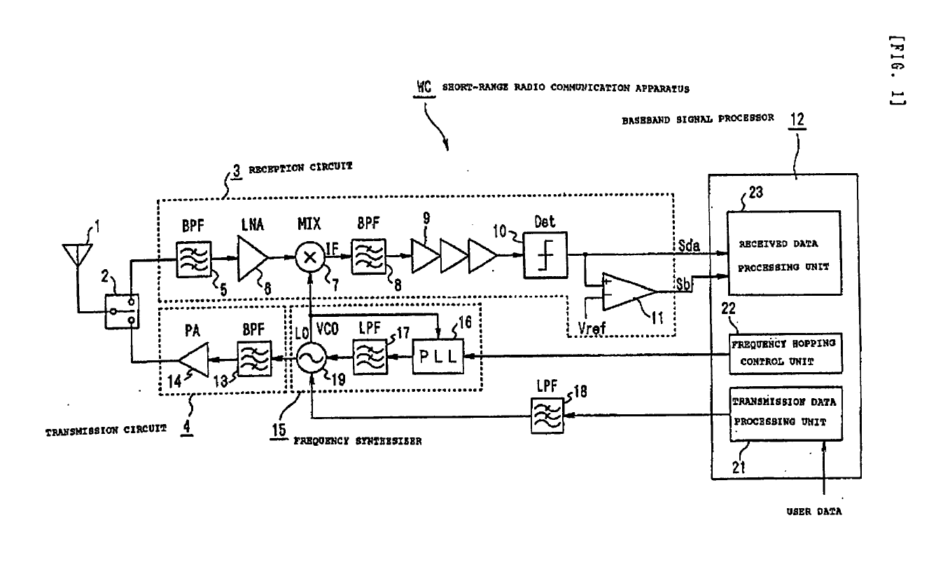

FIG. 1 is a block diagram showing the embodiment of the present invention. In FIG. 1, WC denotes a short-range radio communication apparatus for performing radio communication within a short range of ten to several tens of meters. In this short-range radio communication apparatus, a transmitting/receiving antenna 1 is connected to a transmission/reception switching circuit 2, a reception-side output terminal of the transmission/reception switching circuit 2 is connected to a reception circuit 3 serving as a reception circuit unit, and a transmission-side input terminal thereof is connected a transmission circuit 4.

The reception circuit 3 includes a band-pass filter 5 to which a reception signal output from the transmission/reception switching circuit 2 is input; a low-noise amplifier (LNA) 6 to which a filter output of the band-pass filter 5 is input; a mixer 7 which converts the output signal from the low-noise amplifier 6 to an intermediate-frequency signal IF by using a local oscillation signal LO input from a frequency synthesizer 15 for frequency hopping (described later); a band-pass filter 8 to which the intermediate-frequency signal IF from the mixer 7 is input; a limiter amplifier 9 for amplifying the filter output of the band-pass filter 8; a detection circuit 10 to which the amplification output of the limiter amplifier 9 is input; and a comparator 11 for comparing an analog demodulation signal Sda output from the detection circuit 10 with a reference voltage so as to output a binary signal Sb. The analog demodulation signal Sda output from the detection circuit 10 and the binary signal Sb output from the comparator 11 are input to a baseband signal processor 12 serving as a baseband processing unit.

On the other hand, the transmission circuit 4 includes a band-pass filter 13 to which a transmission signal output from the frequency synthesizer 15 is input and a power amplifier 14 to which the filter output of the band-pass filter 13 is input. The transmission signal output from the power amplifier 14 is supplied to the transmission-side input terminal of the transmission/reception switching circuit 2.

Further, the frequency synthesizer 15 includes a phase-locked loop (PLL) circuit 16 to which a setting signal for setting a frequency hopping output from the baseband signal processor 12 is input; a low-pass filter 17 to which an output signal from the PLL circuit 16 is input; and a voltage-controlled oscillator (VCO) 19 to which the filter output of the low-pass filter 17 is input and transmission data from the baseband signal processor 12 is input through a low-pass filter 18 and which forms a local oscillation signal LO to be input to the mixer 7 of the reception circuit 3 and a transmission signal for frequency hopping. The local oscillation signal LO output from the voltage-controlled oscillator 19 is supplied to the mixer 7 of the reception circuit 3 and the transmission signal is supplied to the transmission circuit 4.

Also, the baseband signal processor 12 includes a transmission data processing unit 21 for processing input user data to be transmitted; a frequency hopping control unit 22 for controlling, with respect to the frequency synthesizer 15, a frequency hopping of an industrial scientific medical (ISM) band of 2.4 GHz band with a predetermined pattern set in advance; and a received data processing unit 23 for processing the analog reception signal Sda and the binary signal Sb supplied from the reception circuit 3.

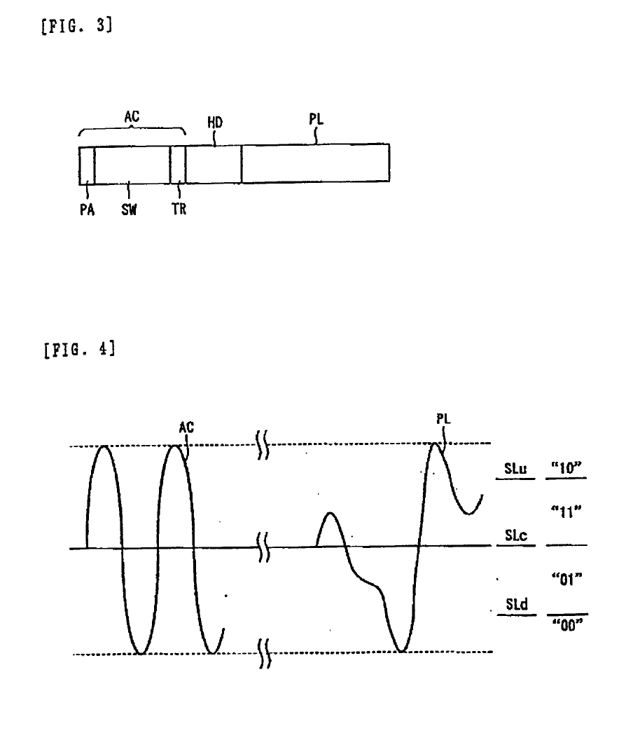

Herein, the transmission data processing unit 21 forms a packet shown in FIG. 3 when user data is input thereto, and outputs the packet to the voltage-controlled oscillator (VCO) 19 of the frequency synthesizer 15. The packet includes an access code part AC of 72 bits, which is placed at the head; a header part HD of 54 bits which is placed next to the access code part AC and which indicates the address and the type of payload part of each device, retransmission control, flow control, and so on; and a payload part PL of 0 to 2745 bits which is placed next to the header part HD and which stores predetermined data. The access code part AC and the header part HD are formed by using 00 and 10 indicating the minimum value and the maximum value respectively in a four-valued signal shown in FIG. 4. The header part HD and the payload part PL are formed by using 00, 01, 11, and 10 of the four-valued signal. This packet is supplied to the frequency synthesizer 15, is modulated with four-valued FSK including a predetermined hoppling frequency, and is then transmitted.

The access code part AC includes a preamble part PA formed by 4 bits of 0101 or 1010, a synchronization word part SW of 64 bits used for identifying the packet, and, if necessary, a trailer part TR which is placed next to the synchronization word part SW and which has 4 bits as in the preamble part PA.

Also, the frequency hopping control unit 22 indicates a frequency hopping with a predetermined hopping pattern, in the range from 2.400 GHz to 2.480 GHz of the ISM band.

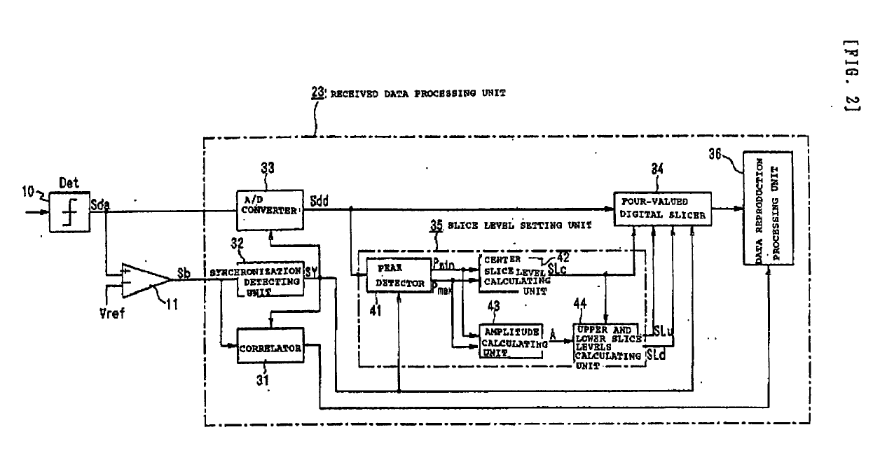

Next, the received data processing unit 23 will be described with reference to FIG. 2. The received data processing unit 23 of the present invention includes at least a correlator 31 to which the binary signal Sb from the comparator 11 of the reception circuit 3 is input and which detects the synchronization word part SW in the access code part AC; a synchronization detecting unit 32 to which the binary signal Sb is input and which serves as synchronization establishing means for establishing synchronization with a 01 pattern of the preamble part PA so as to output a synchronization signal SY; an A/D converter 33 for A/D-converting the analog demodulation signal Sda input from the detection circuit 10 of the reception circuit 3 based on the synchronization signal SY output from the synchronization detecting unit 32 so as to generate a digital demodulation signal Sdd; a four-valued digital slicer 34 for slicing the digital demodulation signal Sdd output from the A/D converter 33 when a correlation signal is output from the correlator 31 by using three slice level reference values so as to generate a four-valued digital signal; a slice level setting unit 35 serving as reference value correcting means for setting the slice level reference values used in the digital slicer 34; and a data reproduction processing unit 36 to which a four-valued digital signal output from the digital slicer 34 is input.

The slice level setting unit 35 includes a peak detector 41 for detecting a minimum peak Pmin and a maximum peak Pmax corresponding to 00 and 10 of a four-valued FSK of the digital demodulation signal Sdd output from the A/D converter 33 when the synchronization signal SY is output from the synchronization detecting unit 32; a center slice level calculating unit 42 for calculating a center value SLc of the slice level based on the minimum peak Pmin and the maximum peak Pmax detected by the peak detector 41; an amplitude calculating unit 43 for calculating an amplitude A of the digital reception signal based on the minimum peak Pmin and the maximum peak Pmax detected by the peak detector 41; and an upper and lower slice levels calculating unit 44 for calculating upper and lower slice levels SLu and SLd sandwiching the center value SLc by adding/subtracting 1/3 of the amplitude A obtained in the amplitude calculating unit 43 to/from the center value SLc obtained in the center slice level calculating unit 42. The center slice level SLc obtained in the center slice level calculating unit 42 and the upper and lower slice levels SLu and SLd obtained in the upper and lower slice levels calculating unit 44 are input as slice level reference values to the four-valued digital slicer 34.

The transmission circuit 4, the frequency synthesizer 15, the transmission data processing unit 21, and the frequency hopping control unit 22 form transmitting means.

Next, the operation of the above-described embodiment will be described.

A packet, in which the access code part AC and the header part HD are formed by 00 and 10 and the payload part PL is a four-valued FSK modulated by using 00, 01, 11, and 10, is transmitted from a short-range radio communication apparatus having the same configuration as that of the short-range radio communication apparatus WC shown in FIG. 1 to the short-range radio communication apparatus WC, while frequency hopping is performed in a frequency band in the range of 2.400 GHz to 2.480 GHz. The packet is received by the transmitting/receiving antenna 1 of the short-range radio communication apparatus WC.

A reception signal received by the transmitting/receiving antenna 1 is supplied to the reception circuit 3 through the transmission/reception switching circuit 2.

In the reception circuit 3, the reception signal is supplied to the band-pass filter 5, the filter 5 extracts only a necessary band, the extracted component of the reception signal is amplified by the low-noise amplifier 6, is mixed with the local oscillation output LO of the voltage-controlled oscillator 19 in the mixer 7, and is converted to an intermediate-frequency signal IF. Then, the intermediate-frequency signal IF is supplied to the band-pass filter 8 so as to remove an image signal generated at the mixing, is amplified in the limiter amplifier 9, and is supplied to the detection circuit 10. A detected analog demodulation signal Sda is directly input to the received data processing unit 23 of the baseband signal processor 12 and a binary signal Sb generated by slicing and binarizing the analog demodulation signal Sda in the comparator 11 is also input to the received data processing unit 23 of the baseband signal processor 12.

In the received data processing unit 23, the synchronization detecting unit 32 establishes synchronization based on the binary signal Sb corresponding to the preamble part PA of the 01 pattern and the synchronization word part SW. Then, after synchronization has been established, a synchronization signal SY is output to the A/D converter 33 and to the peak detector 41 of the slice level setting unit 35.

The A/D converter 33 converts the analog demodulation signal Sda to a digital signal at the timing of indication of the synchronization signal SY. When the digital signal is input to the slice level setting unit 35, the peak detector 41 detects the minimum peak Pmin and the maximum peak Pmax corresponding to 00 and 10 of the four-valued FSK of the synchronization word part SW. The minimum peak Pmin and the maximum peak Pmax are supplied to the center slice level calculating unit 42, where an average is calculated so as to obtain a center slice level SLc. On the other hand, the amplitude calculating unit 43 calculates the amplitude A, which is supplied to the upper and lower slice levels calculating unit 44. The upper and lower slice levels calculating unit 44 calculates the upper and lower slice levels SLu and SLd sandwiching the center slice level SLc based on the amplitude A and the center slice level SLc. The center slice level SLc and the upper and lower slice levels SLu and SLd are supplied to the four-valued digital slicer 34.

On the other hand, in the correlator 31, a shift register sequentially reads data, which is set in the synchronization word part SW and which is used for identifying the packet, in accordance with the synchronization signal SY. Also, the correlator 31 calculates the correlation between the data and an identification word set in advance. When the correlation value reaches its peak and the data matches the identification word, a correlation signal is output to the data reproduction processing unit 36.

The four-valued digital slicer 34 compares the digital demodulation signal Sdd corresponding to the payload part PL with the reference values, that is, the center slice level SLc and the upper and lower slice levels SLu and SLd set in the slice level setting unit 35, and converts the digital demodulation signal Sdd to four digital values: 00, 01, 11, and 10. The digital values are output to the data reproduction processing unit 36 so that the transmission data is reproduced.

As described above, according to the embodiment, the transmitter side transmits a packet, in which the access code part AC including the preamble part PA and the synchronization word part SW and the header part HD are formed by binary of 00 and 10 indicating the minimum value and the maximum value in the four-valued FSK and in which the payload part PL is formed by four values of 00, 01, 11, and 10, by FSK modulation. Accordingly, the receiver side, that is, the short-range radio communication apparatus WC, receives the packet, and the analog demodulation signal Sda detected by the detection circuit 10 and the binary signal Sb generated by binarizing the analog demodulation signal Sda in the comparator 11 are supplied to the received data processing unit 23 of the baseband signal processor 12. Accordingly, in the received data processing unit 23, synchronization can be established and correlation of the synchronization word part can be achieved based on the binary signal Sb. In a state that the synchronization is established, the slice level setting unit 35 calculates the slice level reference values so as to perform correction. Thus, the sampling period of the A/D converter 33 can be lowered and a hardware configuration for calculating the slice level can be simplified.

Further, both of the analog demodulation signal Sda and the binary signal Sb are input to the received data processing unit 23 of the baseband signal processor 12. Thus, when a packet in which the entire packet is binary FSK modulated is received, both of the signals are detected from the header part HD. In this case, when correlation is detected in the correlator 31, the A/D converter 33 can be stopped and the binary signal output from the comparator 11 can be directly supplied to the data reproduction processing unit 36 so as to be reproduced. Also, the power consumption in the AID converter 33 can be significantly reduced, and the power consumption when a binary FSK modulated packet is received can be significantly reduced compared to when a four-valued FSK modulated packet is received.

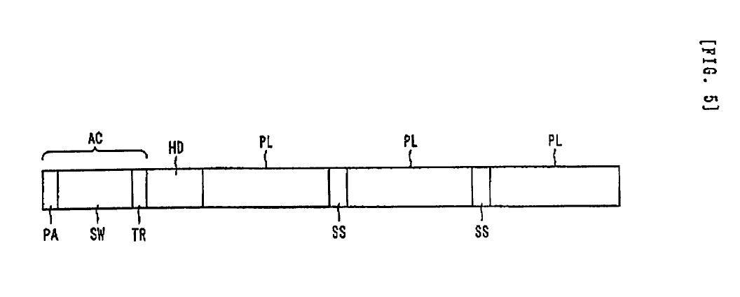

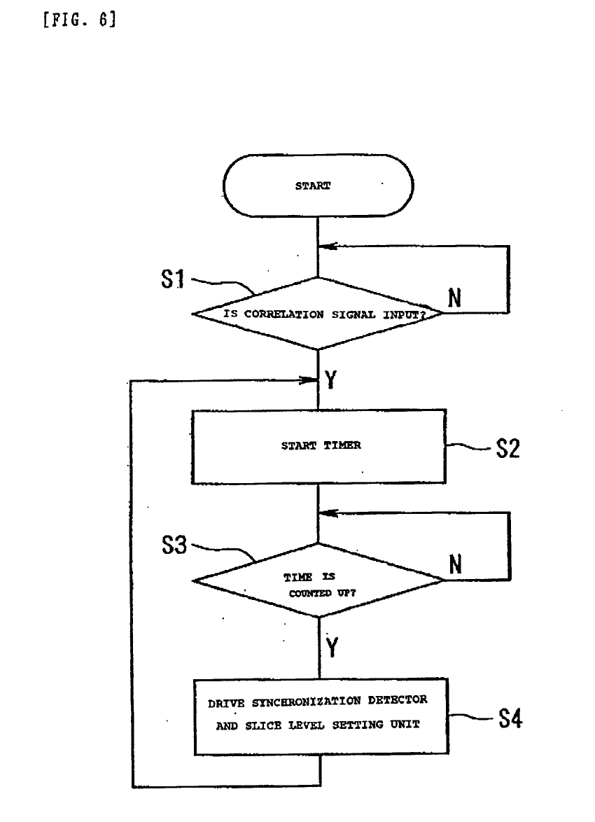

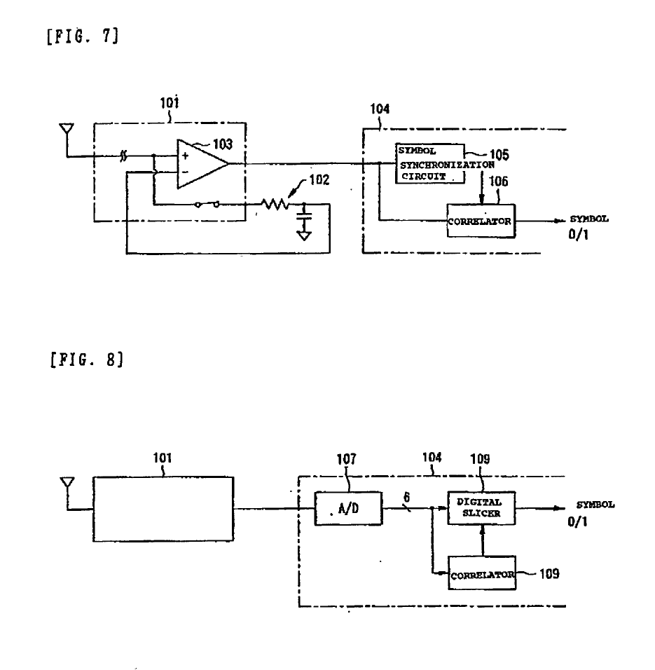

In the above-described embodiment, synchronization and calculation of the slice level reference values are performed in the period of the preamble part PA and the synchronization word part SW of a packet. However, the present invention is not limited thereto. Alternatively, as shown in FIG. 5, the transmitter side can form a packet in which an auxiliary synchronization signal part SS, which is formed by 00 and 10 indicating the minimum value and the maximum value in the four-valued FSK as in the preamble part PA, is inserted into the payload part PL with a predetermined time interval from the start point of the payload part PL subsequent to the access code part AC. Also, the received data processing unit 23 of the baseband signal processor 12 in the receiver side performs a synchronization establishment process illustrated in FIG. 6. In the synchronization establishment process, it is determined whether or not a correlation signal is input from the correlator 31 in step S1. If the correlation signal is not input, it is determined that no packet is received and the process waits until a correlation signal is input. When a correlation signal is input, the process proceeds to step S2, where a timer which is counted up in a predetermined time is started. Then, in step S3, it is determined whether or not the timer is counted up. If the timer is not counted up, the process proceeds to step S4 so as to determine whether or not a payload part PL exists. If a payload part PL does not exist, it is determined that the reception of the packet is completed and the process returns to step S1. If a payload part PL exists, it is determined that a packet is being received and the process returns to step S3. On the other hand, if the timer is counted up in step S3, the process proceeds to step S5, where the synchronization detecting unit 32 and the slice level setting unit 35 are operated for a time in which the auxiliary synchronization signal part SS is processed so as to establish synchronization and set the slice level again. Then, the process returns to step S2.

The process shown in FIG. 6 corresponds to auxiliary synchronization signal position detecting means.

Therefore, by establishing synchronization and setting the slice level every time the auxiliary synchronization signal part SS included in the payload part PL of a packet is detected, stagger of synchronization and slice level caused when the number of bits of the payload part PL is large can be reliably prevented.

In the above-described embodiment, the slice level setting unit sets the center slice level Sc and positive and negative slice levels Sp and Sn based on the digital reception signal output from the A/D converter 33. Alternatively, the center level of the digital reception signal output from the A/D converter 33 is corrected in accordance with the center slice level SLc obtained in the center slice level calculating unit 42 so that the signal is supplied to the four-valued digital slicer 34.

Further, in the above-described embodiment, four-valued FSK modulation/demodulation is described. However, the present invention can be applied when multi-valued FSK communication is performed, for example, eight-valued FSK modulation/demodulation.

In addition, in the above-described embodiment, the present invention is applied to a short-range radio communication apparatus using an ISM band. Alternatively, the present invention can be applied to another type of radio communication apparatus, for example, radio LAM using another band.

As described above, according to the invention of claim 1 or 4, the transmitter side forms the transmission signal by performing multi-valued FSK modulation using only the minimum value and the maximum value in multi-valued FSK with respect to the synchronization signal part of the packet and by performing normal multi-valued FSK modulation with respect to the payload part, and transmits the transmission signal to the receiver side. The receiver side outputs the analog demodulation signal and a binary signal generated by binarizing the analog demodulation signal from a reception circuit unit for demodulating the reception signal to a baseband processing unit. Also, in the baseband processing unit, the reference value for determining the level of multi-valued FSK based on the digital demodulation signal generated by A/D-converting the analog demodulation signal after synchronization is established based on the binary signal is corrected, and then the payload part of the analog demodulation signal is A/D-converted so as to be compared with the reference value, and the multi-valued digital signal is generated. Therefore, establishment of synchronization of the received packet and correction of the reference value can be easily performed with a simple configuration.

Also, the binary signal is generated from the analog demodulation signal in the reception circuit unit and the binary signal is supplied to the baseband processing unit. Thus, a packet of a multi-valued FSK can be reproduced by using the A/D converter and a packet of a binary FSK can be reproduced based on the binary signal without using the A/D converter. Accordingly, power can be saved.

Also, according to the invention of claim 2 or 5, when the frame of the payload part of the packet is long, the transmitter side inserts an auxiliary synchronization signal part corresponding to the synchronization signal part into the payload part with an interval of predetermined time from the end of the synchronization signal part, the baseband processing unit in the receiver side measures the predetermined time from the end of the synchronization signal part, synchronization is established based on the binary signal output from the reception circuit unit every time the predetermined time passes, and the reference value is corrected. Thus, stagger of synchronization and reference value can be reliably prevented even when the frame of the payload part of a packet is long. In this case, special hardware used for integrating and averaging the reference value, which is required in the first known art, is unnecessary. Accordingly, the size and cost of the device can be reduced and low power consumption can be realized.

Further, according to the invention of claim 3 or 6, a large error is not caused when the reference value in the four-valued FSK is corrected, and thus the reference value can be stably corrected.

What is claimed is:

1. A multi-valued FSK communication method, in which a transmitter side forms a transmission signal by multi-valued FSK modulating a packet including a synchronization signal part and a payload part and transmits the transmission signal to a receiver side, the receiver side receives the transmission signal and A/D-converts an analog demodulation signal generated by demodulating a reception signal so as to compare with a reference value, so that a multi-valued digital signal is generated, the method comprising:
in the transmitter side,
forming the transmission signal by performing multi-valued FSK modulation using only the minimum value and the maximum value in multi-valued FSK with respect to the synchronization signal part of the packet and by performing normal multi-valued FSK modulation with respect to the payload part; and
transmitting the transmission signal to the receiver side, and
in the receiver side,
outputting the analog demodulation signal and a binary signal generated by binarizing the analog demodulation signal from a reception circuit unit for demodulating the reception signal to a baseband processing unit; and
in the baseband processing unit, correcting the reference value for determining the level of multi-valued FSK based on a digital demodulation signal generated by A/D-converting the analog demodulation signal after synchronization is established based on the binary signal, and A/D-converting the payload part of the analog demodulation signal so as to compare with the reference value, thereby generating the multi-valued digital signal.

2. The multi-valued FSK communication method according to claim 1, wherein, when the frame of the payload part of the packet is long, the transmitter side inserts an auxiliary synchronization signal part corresponding to the synchronization signal part into the payload part with an interval of predetermined time from the end of the synchronization signal part, the baseband processing unit in the receiver side measures the predetermined time from the end of the synchronization signal part, synchronization is established based on the binary signal output from the reception circuit unit every time the predetermined time passes, and the reference value is corrected by using the digital demodulation signal.

3. The multi-valued FSK communication method according to claim 1 or 2, wherein the multi-valued FSK is set to four-valued FSK.

4. A multi-valued FSK communication apparatus, in which a transmitter forms a transmission signal by multi-valued FSK modulating a packet including a synchronization signal part and a payload part and transmits the transmission signal to a receiver, and the receiver receives the transmission signal and A/D-converts a demodulation signal generated by demodulating a reception signal so as to compare with a reference value, so that a multi-valued digital signal is generated,
wherein the transmitter comprises transmission means for forming the transmission signal by performing multi-valued FSK modulation using only the minimum value and the maximum value in multi-valued FSK with respect to the synchronization signal part of the packet and by performing normal multi-valued FSK modulation with respect to the payload part and for transmitting the transmission signal to the receiver,
and wherein the receiver comprises:
a reception circuit unit for outputting the analog demodulation signal generated by demodulating the reception signal and a binary signal generated by binarizing the analog demodulation signal; and
a baseband processing unit including synchronization establishing means for establishing synchronization based on the binary signal output from the reception circuit unit; reference value correcting means for correcting the reference value for determining the level of multi-valued FSK based on the digital demodulation signal generated by A/D-converting the analog reception signal in the synchronization signal part in a state that the synchronization establishing means has established synchronization; and code determining means for generating the multi-valued digital signal by A/D-converting the analog demodulation signal so as to compare with the reference value.

5. The multi-valued FSK communication apparatus according to claim 4,
wherein the transmitter inserts an auxiliary synchronization signal part corresponding to the synchronization signal part into the payload part with an interval of predetermined time from the end of the synchronization signal part when the frame of the payload part of the packet is long,
the baseband processing unit in the receiver comprises auxiliary synchronization signal position detecting means for detecting the position of an auxiliary synchronization signal by measuring the predetermined time from the end of the synchronization signal part,
the synchronization establishing means establishes synchronization based on the binary signal output from the reception circuit unit when the auxiliary synchronization signal position detecting means detects the auxiliary synchronization signal,
and the reference value correcting means corrects the reference value by using the digital demodulation signal.

6. The multi-valued FSK communication apparatus according to claim 4 or 5, wherein the multi-valued FSK is set to four-valued FSK.
